(19) United States
(12) Patent Application Publication
(10) Pub. No.: US 2019/0042898 A1
(43) Pub. Date: Feb. 7, 2019

(54) Two-dimensional Symbols For Facilitating Machine Learning Of Written Chinese Language Using Logosyllabic Characters

(71) Applicant: GYRFALCON TECHNOLOGY INC., Milpitas, CA (US)

(72) Inventors: Lin Yang, Milpitas, CA (US); Patrick Z. Dong, San Jose, CA (US); Baohua Sun, Fremont, CA (US)

(21) Appl. No.: 15/683,717

(22) Filed: Aug. 22, 2017

Related U.S. Application Data
(60) Provisional application No. 62/541,081, filed on Aug. 3, 2017.

(51) Int. Cl. G06K 9/66; G06N 3/08; G06T 7/11

(52) U.S. Cl. CPC G06K 9/66; G06K 2209/011; G06T 7/11; G06N 3/08

(57) ABSTRACT

Two-dimensional symbol for facilitating machine learning of written Chinese language using logosyllabic characters is disclosed. The two-dimensional symbol comprises a matrix of N×N pixels of data containing a “super-character” that represents a specific form and meaning of written Chinese language. The matrix is divided into M×M sub-matrices with each sub-matrix containing (N/M)×(N/M) pixels. Each of sub-matrix represents one logosyllabric character defined in a standard set (e.g., GB18030). “Super-character” is recognized in a Cellular Neural Networks or Cellular Nonlinear Networks (CNN) based computing system via an image processing technique such as convolution neural networks algorithm. “Super-character” contains a minimum of two and a maximum of M×M characters for representing written Chinese language including, but not necessarily limited to, compounded phrases, idioms, proverbs, written passages, sentences, poems, paragraphs, articles (i.e., written works). N and M are positive integers or whole numbers, and N is preferably a multiple of M.

### CROSS-REFERENCE TO RELATED APPLICATIONS

This application claims priority from a co-pending U.S. Provisional Patent Application Ser. No. 62/541,081, entitled “Two-dimensional Symbol For Facilitating Machine Learning Of Natural Languages Having Logosyllabic Characters” filed on Aug. 3, 2017. The contents of which are incorporated by reference in its entirety for all purposes.

This application is related to a co-pending U.S. patent application Ser. No. ______ for “Two-dimensional Symbols For Facilitating Machine Learning Of Combined Meaning Of Multiple Ideograms Contained Therein” filed on Aug. 22, 2017 by the same inventors.

### FIELD

The invention generally relates to the field of machine learning and more particularly to two-dimensional symbols for facilitating machine learning of written Chinese language using logosyllabic characters or scripts.

### BACKGROUND

Written Chinese language have been traced back around 1000 BC in forms of ancient Chinese characters, which evolve over time and become the modern Chinese characters (i.e., Hanzi in Chinese pinyin system). Chinese characters are logosyllabic; that is, a character generally represent one syllable of spoken Chinese and may be word of its own or a part of polysyllabic word. The characters themselves are often composed of parts that may represent physical objects, abstract notions, or pronunciation. Literacy requires the memorization of a great many characters (e.g., about three- to four-thousands characters). The large number of Chinese characters has in part led to the adoption of Latin alphabets as an auxiliary means of representing Chinese (i.e., Chinese pinyin system). Standardization of Chinese character set has also been evolving over the past decades. One standard is referred to as GB18030, which is a Chinese government standard as “Information technology—Chinese coded character set” for defining entire Chinese character set. All logosyllabic Chinese characters are defined in GB18030.

Traditionally, written Chinese have been learned and mastered with rote learning techniques such as memorization with repetition. Students generally learn the written Chinese language from individual characters, to compound phrases, idioms, proverbs, written passages, sentences, poems, etc.

Machine learning is an application of artificial intelligence. In machine learning, a computer or computing device is programmed to think like human beings so that the computer may be taught to learn on its own. The development of neural networks has been key to teaching computers to think and understand the world in the way human beings do. One particular implementation is referred to as Cellular Neural Networks or Cellular Nonlinear Networks (CNN) based computing system. CNN based computing system has been used in many different fields and problems including, but not limited to, image processing.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Two-dimensional symbols for facilitating machine learning of written Chinese language using logosyllabric characters are disclosed. According to one aspect, two-dimensional symbol comprises a matrix of N×N pixels of data containing a “super-character” that represents specific form and meaning of written Chinese language. The matrix is divided into M×M sub-matrices with each of the sub-matrices containing (N/M)×(N/M) pixels. Each submatrix represents one logosyllabric character defined in a standard set (e.g., GB18030). The “super-character” is recognized in a Cellular Neural Networks or Cellular Nonlinear Networks (CNN) based computing system via an image processing technique such as convolution neural networks algorithm. The “super-character” contains a minimum of two and a maximum of M×M characters. N and M are positive integers or whole numbers, and N is preferably a multiple of M. The “super-character” represents a specific form and meaning of written Chinese language including, but not necessarily limited to, compounded phrases, idioms, proverbs, written passages, sentences, poems, paragraphs, articles (i.e., written works).

In another aspect, data in each pixel of a two-dimensional symbol contains more than one bit for representing grayscale. Multiple shades of grayscale may be used for uniquely representing more than one meaning of a Chinese character.

One of the objectives, features and advantages of the invention is to use a two-dimensional symbol for representing more than individual logosyllabic script or character (e.g., Chinese character). Such a two-dimensional symbol facilitates a CNN based computing system to learn the meaning of a specific combination of a plurality of Chinese characters contained in a “super-character” using image processing techniques e.g., convolutional neural networks, recurrent neural networks, etc.

Other objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1 is a diagram illustrating an example two-dimensional symbol comprising a matrix of N×N pixels of data that contains a “super-character” for facilitating machine learning of written Chinese language in accordance with one embodiment of the invention;

FIGS. 2A-2B are diagrams showing example partition schemes for dividing the two-dimensional symbol of FIG. 1 in accordance with embodiments of the invention;

FIG. 3A shows example logosyllabic Chinese characters in accordance with an embodiment of the invention;

FIG. 3B shows example punctuation mark, numeral and special character in accordance with an embodiment the invention

FIG. 3C shows an example logosyllabic Chinese character having multiple meanings in accordance with an embodiment of the invention; and

FIG. 4 is block diagram illustrating an example Cellular Neural Networks or Cellular Nonlinear Networks (CNN) based computing system for machine learning of a combined meaning of multiple Chinese characters contained in a two-dimensional symbol, according to one embodiment of the invention.

### DETAILED DESCRIPTIONS

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “vertical”, “horizontal”, “left”, “right”, “upper”, “lower”, “column”, “row” are intended to provide relative positions for the purposes of description, and are not intended to designate an absolute frame of reference. Additionally, used herein, term “character” and “script” are used interchangeably.

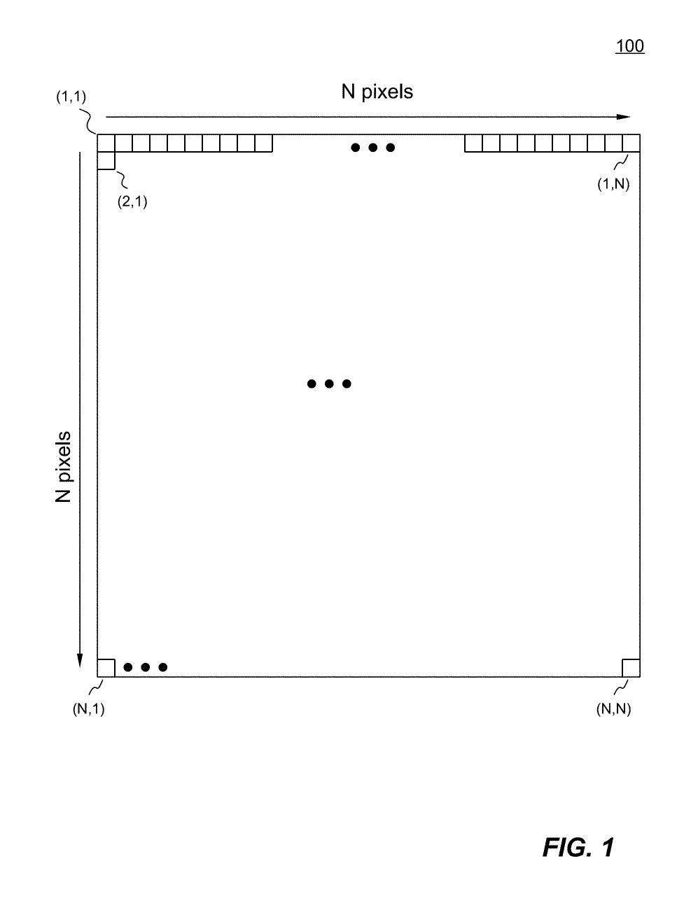

Embodiments of the invention are discussed herein with reference to FIGS. 1-4. However, those skilled in the art will readily appreciate that the detailed description given herein with respect to these figures is for explanatory purposes as the invention extends beyond these limited embodiments.

Referring first to FIG. 1, it is shown a diagram showing an example two-dimensional symbol 100 for facilitating machine learning of written Chinese language in accordance with one embodiment of the invention. The two-dimensional symbol 100 comprises a matrix of N×N pixels (i.e., N columns by N rows) of data containing a “super-character” that represents specific form and meaning of written Chinese language. Pixels are ordered with row first and column second as follows: (1,1), (1,2), (1,3), . . . (1,N), (2,1), . . . , (N,1), . . . (N,N). N is a positive integer or whole number, for example in one embodiment, N is equal to 224.

Since each logosyllabic Chinese character can be represented in a certain size matrix of pixels, the two-dimensional symbol 100 may be divided into M×M sub-matrices for each character. Each of the sub-matrices represents one logosyllabic character defined in a character set, for example, GB18030 for all Chinese characters.

The “super-character” contains a minimum of two and a maximum of M×M characters. Both N and M are positive integers or whole numbers, and N is preferably a multiple of M. The “super-character” represents a specific form and meaning of written Chinese language including, but not necessarily limited to, compounded phrases, idioms, proverbs, written passages, sentences, poems, paragraphs, articles (i.e., written works). In certain instances, the “super-character” may be in a particular area of the written Chinese language. The particular area may include, but is not limited to, certain folk stories, historic periods, specific backgrounds, etc.

The “super-character” may contain more than one meanings in certain instances. “Super-character” can tolerate certain errors that can be corrected with error-correction techniques. In other words, the pixels represent logosyllabic characters do not have to be exact. The errors may have different causes, for example, data corruptions, during data retrieval, etc.

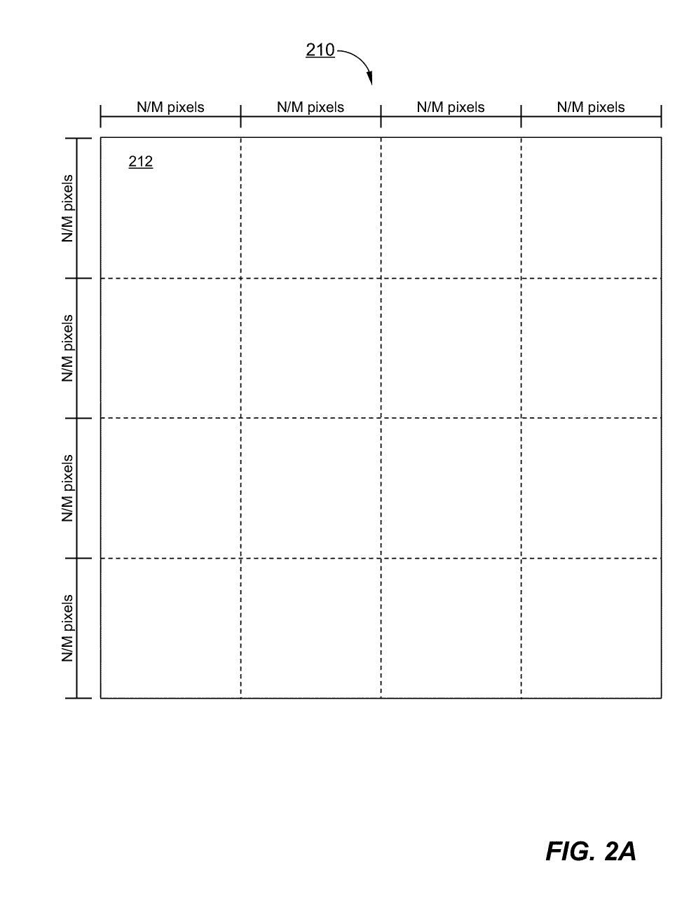

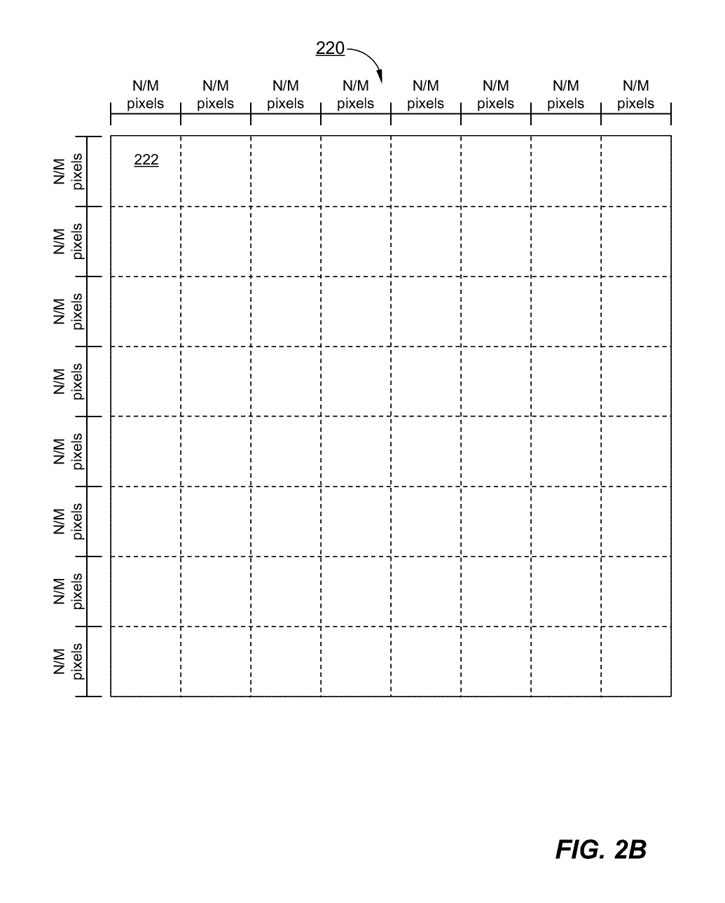

Shown in FIG. 2A, it is a first example partition scheme 210 of dividing a two-dimension symbol into M×M sub-matrices 212. M is equal to 4 in the first example partition scheme. Each of the M×M sub-matrices 212 contains (N/M)×(N/M) pixels. When N is equal to 224, each sub-matrix contains 56×56 pixels and there are 16 submatrices.

A second example partition scheme 220 of dividing a two-dimension symbol into M×M sub-matrices 222 is shown in FIG. 2B. M is equal to 8 in the second example partition scheme. Each of the M×M sub-matrices 222 contains (N/M)×(N/M) pixels. When N is equal to 224, each sub-matrix contains 28×28 pixels and there are 64 submatrices.

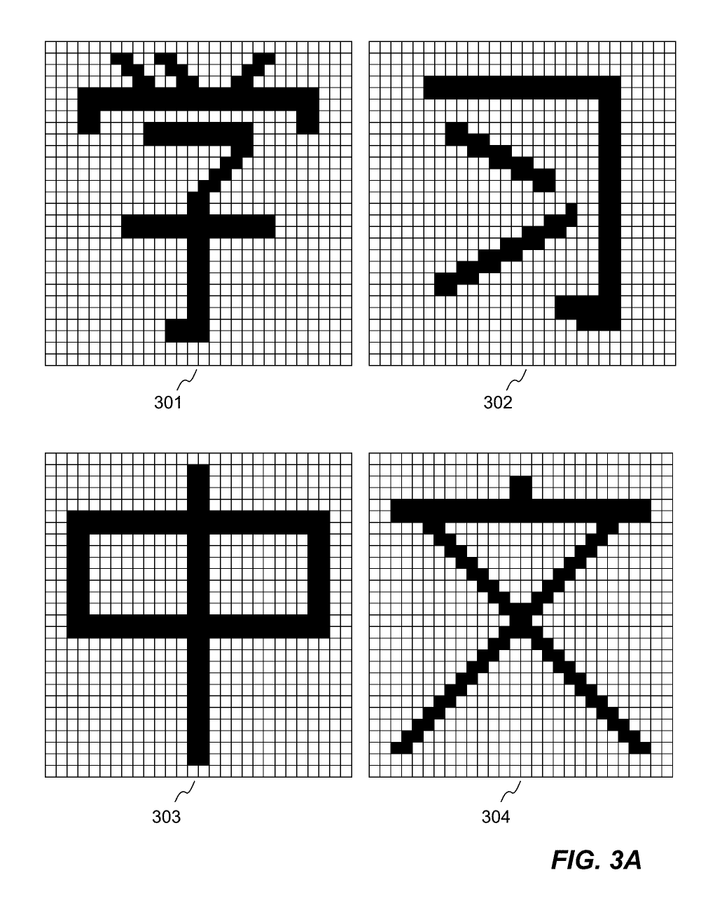

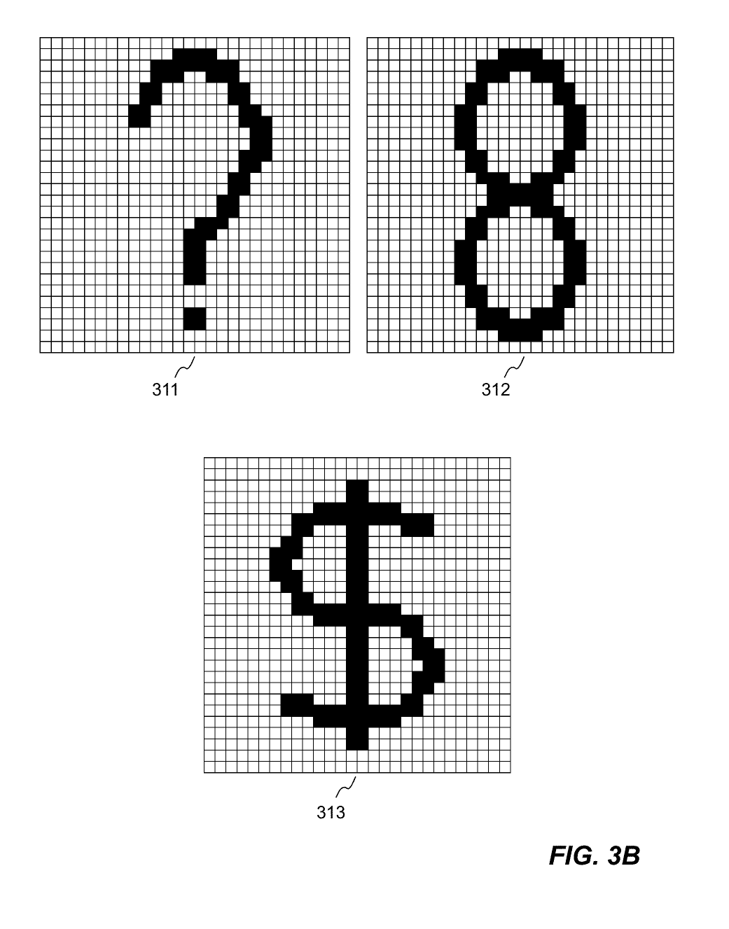

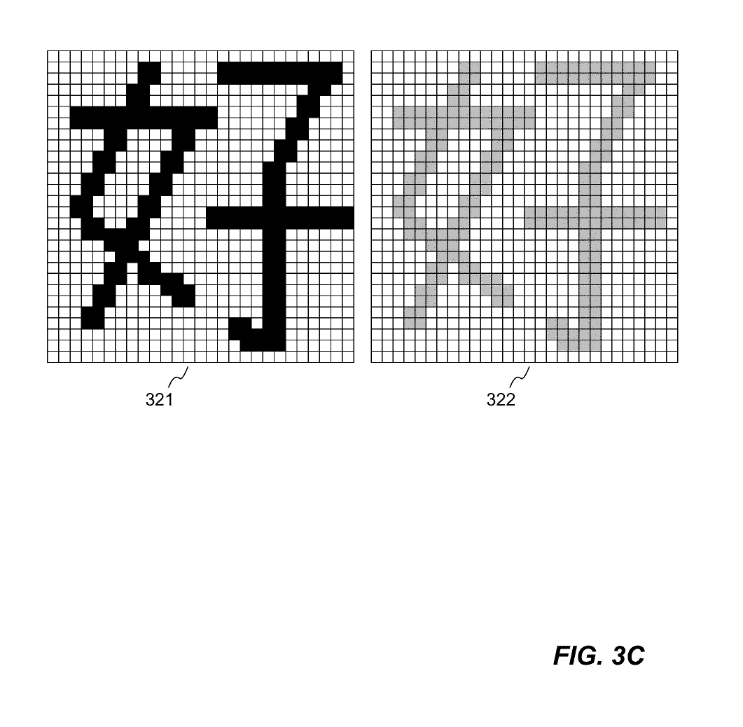

FIG. 3 shows example Chinese characters 301-304 that can be represented in a sub-matrix 222 (i.e., 28×28 pixels). For those having ordinary skill in the art would understand that the sub-matrix 212 having 56×56 pixels can also be adapted for representing these logosyllabic characters. Four example Chinese characters 301-304 shown in FIG. 3A means learning Chinese language. Since showing logosyllabic characters requires only black and white, each pixel of the two-dimensional symbol needs to contain a binary number of at least one-bit. In additional to the logosyllabic characters, a character set may also contain punctuation marks, numerals, special characters. FIG. 3B shows such examples: a punctuation mark 311, a numeral 312 and a special character 313.

Three respective basic color layers of an ideogram (i.e., red, green and blue) are used collectively for representing different colors. Similarly, grayscale shades can be represented using one two-dimensional symbol having each pixel containing more than one bit of data. To accomplish that in one embodiment, data in each pixel must contain more than one bit, for example, K-bit, where K is a positive integer or whole number. In one embodiment, K is 5. In another embodiment K is 8.

Certain Chinese characters can have multiple meanings. In order to differentiate one Chinese character with multiple meanings, different grayscale shades may be used for uniquely representing them. For example, with K-bit of data in each pixel of two-dimensional symbol, an logosyllabic character can have multiple different grayscale shades. Therefore, multiple meanings can be uniquely linked to respective grayscale shades.

An example showing an example Chinese character having multiple meanings is shown in FIG. 3C. The example Chinese character is shown in two different shades of grayscale: first version 321 in black, second version 322 in gray. This example Chinese character has at least two meanings. The first version 321 may be assigned a first meaning of “good” as an adjective or adverb. The second version 322 may be assigned a second meaning of “to like” as a verb or a noun.

A specific combined meaning of Chinese characters contained in a “super-character” is a result of using image processing techniques in a Cellular Neural Networks or Cellular Nonlinear Networks (CNN) based computing system. Image processing techniques include, but are not limited to, convolutional neural networks, recurrent neural networks, etc.

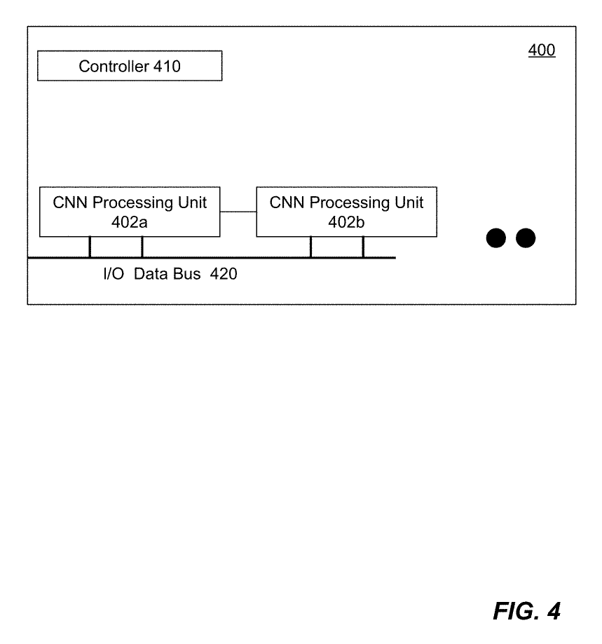

Referring now to FIG. 4, it is shown a block diagram illustrating an example CNN based computing system 400 configured for machine learning of a combined meaning of multiple Chinese characters contained in a two-dimensional symbol (e.g., the two-dimensional symbol 100).

The CNN based computing system 400 may be implemented on integrated circuits as a digital semi-conductor chip (e.g., a silicon substrate) and contains a controller 410, and a plurality of CNN processing units 402a-402b operatively coupled to at least one input/output (I/O) data bus 420. Controller 410 is configured to control various operations of the CNN processing units 402a-402b, which are connected in a loop with a clock-skew circuit.

In one embodiment, each of the CNN processing units 402a-402b is configured for processing imagery data, for example, two-dimensional symbol 100 of FIG. 1.

In another embodiment, the CNN based computing system is a digital integrated circuit that can be extendable and scalable. For example, multiple copies of the digital integrated circuit may be implemented on a single semi-conductor chip.

To store a character set, one or more storage units operatively coupled to the CNN based computing system 400 are required. Storage units (not shown) can be located either inside or outside the CNN based computing system 400 based on well known techniques.

Although the invention has been described with reference to specific embodiments thereof, these embodiments are merely illustrative, and not restrictive of, the invention. Various modifications or changes to the specifically disclosed example embodiments will be suggested to persons skilled in the art. For example, whereas the two-dimensional symbol has been described and shown with a specific example of a matrix of 224×224 pixels, other sizes may be used for achieving substantially similar objections of the invention. Additionally, whereas two example partition schemes have been described and shown, other suitable partition scheme may be used for achieving the same. In summary, the scope of the invention should not be restricted to the specific example embodiments disclosed herein, and all modifications that are readily suggested to those of ordinary skill in the art should be included within the spirit and purview of this application and scope of the appended claims.

What is claimed is:

1. A two-dimensional symbol for facilitating machine learning of written Chinese language comprising:
a matrix of N×N pixels of data containing a “super-character” that represents a specific form and meaning of written Chinese language; and
the matrix being divided into M×M sub-matrices with each of the sub-matrices containing (N/M)×(N/M) pixels, said each of the sub-matrices representing one logosyllabic character defined in a character set, where N and M are positive integers or whole numbers and the N is a multiple of M.

2. The two-dimensional symbol of claim 1, wherein the “super-character” is extracted out of the matrix in a Cellular Neural Networks or Cellular Nonlinear Networks (CNN) based computing system using an image processing technique.

3. The two-dimensional symbol of claim 2, wherein the image processing technique comprises a convolution neural networks algorithm.

4. The two-dimensional symbol of claim 3, wherein the CNN based computing system comprises a semi-conductor chip containing digital circuits dedicated for performing the convolution neural networks algorithm.

5. The two-dimensional symbol of claim 1, wherein the “super-character” comprises a minimum of two and a maximum of M×M logosyllabic characters.

6. The two-dimensional symbol of claim 1, wherein the “super-character” comprises a Chinese compounded phrase.

7. The two-dimensional symbol of claim 1, wherein the “super-character” comprises a Chinese idiom.

8. The two-dimensional symbol of claim 1, wherein the “super-character” comprises a Chinese proverb.

9. The two-dimensional symbol of claim 1, wherein the “super-character” comprises a Chinese poem.

10. The two-dimensional symbol of claim 1, wherein the “super-character” comprises a Chinese sentence.

11. The two-dimensional symbol of claim 1, wherein the “super-character” comprises a Chinese written passage.

12. The two-dimensional symbol of claim 1, wherein the “super-character” comprises a Chinese article.

13. The two-dimensional symbol of claim 1, wherein N is 224, M is 4 and N/M is 56.

14. The two-dimensional symbol of claim 1, wherein N is 224, M is 8 and N/M is 28.

15. The two-dimensional symbol of claim 1, wherein the data in each of the N×N pixels comprises a K-bit binary number, where K is a positive integer or whole number.

16. The two-dimensional symbol of claim 15, wherein K is 1 for representing black and white.

17. The two-dimensional symbol of claim 15, wherein K is larger than 1 for representing grayscale shades.

18. The two-dimensional symbol of claim 17, wherein each of the grayscale shades represents a corresponding meaning of a Chinese character having multiple meanings.

19. The two-dimensional symbol of claim 1, wherein the character set comprises Chinese characters, punctuation marks, numerals and special characters.

20. The two-dimensional symbol of claim 19, wherein the Chinese characters are defined in GB18030.
